(19) United States
(12) Patent Application Publication
(10) Pub. No.: US 2015/0192543 A1
(43) Pub. Date: Jul. 9, 2015

(54) INTEGRATED REAGENTLESS SAMPLE PREPROCESSING FOR MOLECULAR DIAGNOSTICS USING A NANOPOROUS MEMBRANE BASED MICROFLUIDIC DEVICE

(71) Applicant: Ponnambalam Selvaganapathy, Dundas (CA)

(72) Inventor: Ponnambalam Selvaganapathy, Dundas (CA)

(21) Appl. No.: 14/509,665

(22) Filed: Oct. 8, 2014

Related U.S. Application Data
(60) Provisional application No. 61/888,095, filed on Oct. 8, 2013.

(51) Int. Cl. G01N 27/447

(52) U.S. Cl. CPC G01N 27/44791

(57) ABSTRACT

A device and associated method to concentrate cells such as bacteria/viruses, lyse them, and extract biomolecules such as DNA is described. A nanoporous membrane is sandwiched between two microfluidic channels to create thousands of parallel nanopore traps for bacteria or viruses. The application of an electric potential across the membrane results in the electrophoretic accumulation of cells at the nanoporous membrane. The application of moderate voltages is able to produce a high local electric field for lysis of the cells or the disintegration of the virus particles resulting in the extraction of biomolecules such as DNA.

### RELATED APPLICATIONS

This application claims priority to U.S. Provisional Patent Application Ser. No. 61/888,095 filed Oct. 8, 2013, the entire contents of which are hereby incorporated by reference.

### FIELD OF THE INVENTION

The following invention relates to a method and device for processing biological samples and more specifically to a method and device for concentrating and lysing cells using a nanoporous membrane.

### BACKGROUND OF THE INVENTION

Microbiological contamination of water is one of the major reasons for waterborne diseases. Conventional culture-based methods for its detection are time consuming and compromise the timeliness of health advisory warnings¹. Moreover, since some pathogens remain in viable but non-cultureable state, these techniques may underestimate the total number of viable bacteria¹. Molecular biology-based approaches such as identifying unique stretches of DNA that are specific to particular pathogen n and analyzing its presence in water sample are accurate, extremely sensitive and can be performed rapidly. Appropriate sample preparation steps are needed before analyzing these biomarkers^{3,4}. In the case of environmental samples such as water, typically a large volume of sample (500 ml) has to be concentrated, the bacterial contents lysed and the DNA and other biomarkers that are embedded in the cells extracted for analysis. Recently, microfluidic lab-on-chip technology has been used for sample preparation and detection of biomarkers such as DNA and proteins for medical diagnostics in an automated fashion from small samples^{5,6,7,8}.

An important step in sample pre-treatment is cell lysis. Conventionally, in the laboratory, chemical and mechanical methods are used to lyse the cell⁹. Recently, a number of microfluidic devices have been developed that lyse cells using chemical, thermal, mechanical, electrical and electrochemical methods^{10,11,12,13,14,15,16}. The chemical method is the most widely used technique and it has well established protocols¹⁰. In this method, the sample is mixed with various lytic agents such as sodium dodecyl sulphate (SDS), triton X-100 or proteinase K¹¹. The lytic agents interact with phospholipids on the membrane surface which results in pore formation. Alternatively, DI (Deionized) water has been mixed with the sample to generate an osmotic pressure difference across the cell membrane which then leads to cell lysis¹². Although chemical methods are widely used for cell lysis, they require reagents and additional unit operations^{17,18,19} such as mixing, and are more suited for laboratory rather than field settings. In addition, the chemical reagents used in lysis may interfere with downstream processes such as amplification and therefore necessitate an additional DNA extraction step²⁰.

Thermal methods are also used for DNA lysis in microfabricated devices. Exposure to elevated temperatures (>100° C.) for short durations of time ruptures the cell membrane. However, thermal methods are not suitable for large samples that contain low concentrations of bacteria¹³ as their efficiency is very low. Alternatively, cells can be lysed by mechanical impingement on nanoscale barbs as they are flowed through the device. Though this method is very efficient, it has some drawbacks. Cell debris produced by this method consists of very small fragments which are very hard to separate from DNA¹³. In addition, the fabrication of the nanoscale mechanical barbs is difficult and costlyl^{4,21}. Recently, cells have been lysed electrochemically by local hydroxide ion generation^{16,22}. In an alkali environment, excess OH⁻ ions cleave the fatty acid-glycerol bond in phospholipid molecules, resulting in lysis. Again, this requires a constant current flow into the sample to generate the appropriate pH and is therefore energy intensive. Furthermore, this method does not separate the DNA from the rest of the cell debris that could potentially contain inhibitors for downstream processes. It could also lead to irreversible denaturation of the target DNA. In addition this method also requires some degree of photolithographic microfabrication to form the microelectrodes that generate OH⁻ ions making it expensive. A variation of this method has been demonstrated in which titanium dioxide particles are used as photocatalyst to generate the OH⁻ ions upon excitation from a UV LED light source. A continuous supply of UV was needed and the time required to lyse cells was high²³.

In contrast to the above methods, the direct application of electrical pulses to a cell can also damage the cell membrane and form pores in a process known as electroporation. Electroporation was originally developed in the early 1980s, as a method to temporarily damage the cell membrane and form pores through which external genetic material could be inserted into the cells²⁴. If the duration of the electric pulse is short then the membrane reforms and the cell is viable again. Long pulses or DC potentials have been applied to irreversibly damage the cell membrane and lyse the mammalian cell without the use of reagents^{25,26}. Electrical lysis requires high electric field (critical electric field 1 kV/cm-2 kV/cm^{15,27}) that have been obtained in microfluidic devices by application of a high voltage or a reduction the distance between electrodes through microfabrication^{27,28}. However, microfabricated electrodes are expensive and necessitate the use of AC and pulsed electric fields to avoid bubble generation and clogging^{29,30}. Recently, DC voltages have been used to lyse bacteria³¹ and red blood cells³² in a continuous flow through manner. Although, promising, these designs consume significant power and do not concentrate the lysed DNA into a small volume which is important for environmental applications.

### SUMMARY OF THE INVENTION

In one aspect, there is provided a method and a microfluidic device for electrophoretically pre-concentrating cells from a sample and optionally lysing the cells using a localized high electric field. In one embodiment, the methods and devices described herein can also be used to extract negatively charged biomolecules, such as nucleic acid molecules, across a nanoporous membrane that separates two microchannels. Optionally, the biomolecules can then be assayed for the presence or absence of target biomolecules or nucleic acid sequences that are indicative of contaminants such as E. coli within the sample or for biomarkers associated with a disease, disorder or infectious state.

As set out in the Examples, the inventor has demonstrated the use of a method and associated microfluidic device for concentrating cells from a sample on a nanoporous membrane between two microchannels and has demonstrated the use of the device for lysing cells and extracting DNA. In one embodiment, the methods and devices described herein may be used for processing and lysing cells or virus particles to extract biomolecules previously found within the cells or virus particles such as nucleic acid molecules. Applying an electric potential across the nanoporous membrane produce a high local electric field for lysis of cells at moderate applied voltages under an appropriate range of electric field (>1000 V/cm). The accumulation and lysis of bacterial cells on a nanoporous membrane was demonstrated using fluorescent markers and quantified by fluorescence intensity measurements. Remarkably, the efficiency of the device and method was also determined through bacterial culture of the lysate and found to be 90% when a potential of 300 V was applied for 3 min.

In one embodiment, the method and device described herein is useful for preparing nucleic acid samples for amplification such as by a polymerase chain reaction or other amplification techniques. Optionally, the device may integrate reagents for the detection of a target biomolecule such as PCR primers and a polymerase enzyme and/or a heating element to facilitate amplification of a target nucleic acid such as by PCR.

The method and device described herein present a number of advantages for the processing of samples containing cells and/or virus particles, particularly for use in molecular diagnostics. In one embodiment, the throughput of the device can also be increased by either increasing the cross-sectional area of the membrane interface or by parallelizing the format. The method and device are also capable of lysing cells from various matrices in a reagent free and simple manner and present significant potential for compact lab-on-chip style devices. In some embodiments, the method and device described avoids the typical problems associated with electrical cell lysis such as Joule heating and bubble generation due to its continuous flow operation and the use of lower voltages. In some embodiments, the method and device described herein are useful for concentrating cells and then lysing the cells without requiring the use of microfabricated electrodes or lysis reagents.

Accordingly, in one aspect there is provided a microfluidic device comprising a first microchannel, a second microchannel and a nanoporous membrane comprising a plurality of pores separating the first microchannel from the second microchannel. In one embodiment, the device comprises a first electrode positioned within the first microchannel and a second electrode positioned with the second microchannel for applying an electric potential across the nanoporous membrane. For example, the electrodes may be positioned near the nanoporous membrane or at one or the other ends of the microchannel such as in a fluid reservoir. In one embodiment, application of an electric potential to the electrodes generates an electric field across the nanoporous membrane and cells carrying an electric charge in the first microchannel are attracted to the nanoporous membrane through an electrophoretic force.

In one embodiment, the first and second microchannels have one or more sample inlets and/or outlets for introducing or removing samples or other liquids such as buffers from the microchannels. For example, in one embodiment, the first microchannel comprises a sample inlet and a sample outlet. In one embodiment, the nanoporous membrane is positioned between the sample inlet and the sample outlet such that a liquid sample flowing through the first microchannel from the sample inlet to the sample outlet flows past the nanoporous membrane. In one embodiment, the second microchannel comprises an inlet and an outlet and the nanoporous membrane is positioned between the second microchannel inlet and the second microchannel outlet.

The microfluidic device may be made from a variety of different materials known in the art. For example, in one embodiment the first microchannel and/or second microchannel comprises polydimethyl siloxane (PDMS), polystyrene, polycarbonate, silicon, glass, polyester, rubber, polyethylene, epoxy, or polyurethane. Optionally, the materials may be coated and/or treated to improve their properties for use in the methods and devices described herein. In one embodiment, the first microchannel and/or second microchannel is made of polydimethyl siloxane (PDMS).

In one aspect, the nanoporous membrane has a plurality of pores that are sized so as to allow the passage of biomolecules such as nucleic acid molecules or proteins through the pores but are too small to allow the passage of intact cells or larger cell fragments through the membrane. In one embodiment the pores allow for the passage of biomolecules between the first microchannel and the second microchannel and do not allow for the passage of cells from the first microchannel to the second microchannel. In some embodiment, the pores have a diameter between 1 nm and 1 um, optionally a diameter between 0.5 um and 0.2 um.

The nanoporous membrane may be made from a variety of different materials known in the art. For example, in one embodiment the nanoporous membrane comprises polycarbonate, polyester, polyethersoulfone, glass, silicon, silicon dioxide, silicon nitride, polystyrene or rubber. In a preferred embodiment, the nanoporous membrane comprises polyvinylpyrrolidone (PVP) coated polycarbonate.

In one embodiment, the surface area of the nanoporous membrane separating the first microchannel and the second microchannel is between 100 um² and 100,000 um², optionally between 1000 um² and 10,000 um². In some embodiments, a plurality of nanoporous membranes are used to separate the first microchannel and the second microchannel or a plurality of nanoporous membranes may be used to separate a plurality of first microchannels that are optionally in fluid communication with each other from a plurality of second microchannels that are optionally in fluid communication with each other.

In one embodiment, the microfluidic device described herein may include one or more fluid handling devices such as a pump for controlling the flow of a liquid through the first microchannel or second microchannel. In one embodiment the device comprises at least one pump for controlling the flow of a liquid sample through the first microchannel.

In one embodiment, the microfluidic device described herein is useful for processing samples for use in molecular diagnostics whereby a sample is assayed for the presence or absence of one or more target biomolecules. For example, in one embodiment, the second microchannel comprises reagents for the detection of one or more target biomolecules such as a nucleic acid or protein. In one embodiment, the reagents include antibodies for the detection of a target protein or primers, dideoxynucleotides and a polymerase enzyme suitable for performing PCR or another amplification technique.

The microfluidic device described herein may also be combined with other devices such as a heating element. In one embodiment, the microfluidic device comprises a heating element for heating the second microchannel and optionally performing amplification of one or more nucleic acid molecules in the second microchannel, such as by PCR or other techniques that involves controlling the temperature of the sample.

In one aspect, there is also provided a method for processing and lysing cells. In one embodiment, there is provided a method for processing and lysing cells using a microfluidic device as described herein. In one embodiment, the method comprises introducing a sample comprising one or more cells into a first microchannel and applying a first electric potential across a nanoporous membrane separating the first microchannel from a second microchannel. In one embodiment, applying the first electric potential across the nanoporous membrane generates an electrophoretic force acting on the cells in the first microchannel so that cells in first microchannel are attracted to the nanoporous membrane. In one embodiment, the method also comprises applying a second electric potential across the nanoporous membrane so that the cells attracted to the surface of the nanoporous membrane are lysed releasing one or more biomolecules previously found in the cells. In one embodiment, the one or more biomolecules are then forced across the nanoporous membrane into the second microchannel by an electrophoretic force acting on the one or more biomolecules.

In a preferred embodiment, the biomolecules are negatively charged biomolecules such as nucleic acid molecules. In one embodiment a buffer and/or the pH of a solution within the first and/or second microchannels is selected such that cells, viruses and/or nucleic acid molecules carry a negative charge.

In one embodiment, the nanoporous membrane allows for the passage of biomolecules between the first microchannel and the second microchannel and does not allow for the passage of cells or intact viral particles from the first microchannel to the second microchannel. In one embodiment, the nanoporous membrane comprises a plurality of pores with a diameter between 1 nm and 1 um, or between 0.5 um and 0.2 um. In one embodiment, the nanoporous membrane comprises polycarbonate, polyester, polyethersoulfone, glass, silicon, silicon dioxide, silicon nitride, polystyrene or rubber. In a preferred embodiment, the nanoporous membrane comprises polyvinylpyrrolidone (PVP) coated polycarbonate.

A variety of different kinds of samples containing one or more cells or viruses may be processed using the microfluidic device or method described herein. In one embodiment, the sample is an environmental sample such as a water sample or a diagnostic sample obtained from a subject such as a human or other animal. In one embodiment, the sample comprises a bodily fluid that contains one or more cells or virus particles, such as urine, saliva, blood, mucus, faeces or spinal fluid. Optionally, the sample may be processed such as to remove contaminants prior to processing the sample using the method and devices described herein.

In one embodiment, the sample is flowed past the nanoporous membrane in the first microchannel. For example, in one embodiment a pump is used to control the flow of sample, or other liquids such as a buffer, through the first and/or second microchannels. In one embodiment, the method comprises continuously or intermittently flowing the sample through the first microchannel past the nanoporous membrane.

In one embodiment the sample is continuously flowed through the first microchannel past the nanoporous membrane while applying a first electric potential across the nanoporous membrane to attract cells to the nanoporous membrane. In one embodiment, the flow of the sample across the nanoporous membrane is stopped or reduced while applying a second electric potential across the membrane to lyse the cells and release one or more biomolecules. In one embodiment, the one or more biomolecules are then forced across the nanoporous membrane into the second microchannel while the flow of sample is the first microchannel is stopped or reduced. In some embodiments, biomolecules in the second microchannel are then removed from the volume adjacent to the nanoporous membrane by flowing a collection stream through the second microchannel. In some embodiments, the biomolecules in the second microchannel are moved by an electrophoretic force towards an electrode in the second microchannel. Optionally, the electrode in the second microchannel is positioned away from the nanoporous membrane such as in a reservoir or collection chamber.

In one embodiment, the flow of the sample in the first microchannel is in the same direction as the electrophoretic force acting on the one or more cells in the first microchannel. In another embodiment, the flow of the sample in the first microchannel is in the opposite direction as the electrophoretic force acting on the one or more cells in the first microchannel. In one embodiment, the direction of the electrophoretic force may be varied by positioning electrodes on different sides of nanoporous membrane within the microchannels. In one embodiment, the flow of the sample in the first microchannel may be controlled by positioning one or more inlets and outlets on either side of the nanoporous membrane, and optionally, controlling the rate of flow using a pump. Optionally the flow of a collection stream in the second microchannel may be controlled by positioning one or more inlets and outlets on either side of the nanoporous membrane and the use of a separate pump for controlling flow within the second microchannel.

Optionally, the methods described herein include multiple cycles of applying a first electric potential across the nanoporous membrane to attract cells to the nanoporous membrane, applying a second electric potential across the nanoporous membrane to lyse the cells and extracting biomolecules across the nanoporous membrane into the second microchannel.

In one embodiment, the method and device described herein may be used to simultaneously attract and lyse cells. For example, in one embodiment, the first and second electric potentials are the same and selected to be sufficiently high to lyse the cells such that the one or more cells in the first microchannel are simultaneously attracted to the nanoporous membrane and lysed.

In one embodiment, the method and device described herein are used to first attract and concentrate cells to the nanoporous membrane and then lyse the cells. For example in one embodiment, the first electric potential is less than the second electric potential and the first electric potential is applied across the nanoporous membrane for a first time period such that the concentration of cells in the first microchannel near the nanoporous membrane is increased prior to applying the second electric potential and lysing the cells.

The methods described herein optionally include assaying the biomolecules in the second microchannel for the presence or absence of one or more target biomolecules. The biomolecules extracted into the second microchannel may be assayed in situ, or first removed from the second microchannel such as by the use of a pump to generate a collection stream, and then analyzing the collected sample. In a preferred embodiment, the extracted biomolecules in the second microchannel may be assayed for the presence of one or more nucleic acids, such as nucleic acids that are indicative of a particular pathogen, disease or disorder.

In one embodiment, assaying the biomolecules in the second microchannel for the presence or absence of one or more target biomolecules comprises Polymerase Chain Reaction (PCR), real-time PCR, reverse transcriptase PCR, Loop-mediated isothermal amplification (LAMP), Helicase dependent amplification or Transcription-Mediated Amplification (TMA) or other techniques known in the art for the amplification or detection of nucleic acid molecules.

Further aspects and advantages of the embodiments described herein will appear from the following description taken together with the accompanying drawings.

### BRIEF DESCRIPTION OF THE DRAWINGS

FIGS. 1A and 1B show the mechanism of cell electroporation in an electric field. FIG. 1C is a schematic showing the difference between a cell exposed to a lower electric field resulting in temporary holes in the cell membrane and a cell exposed to a higher electric field and/or for a longer period of time resulting in cell lysis.

FIG. 2A shows a schematic of one embodiment of the microfluidic device described herein. FIG. 2B shows one embodiment of an equivalent circuit of the device.

FIG. 3 shows a schematic of forces acting on a bacterial cell.

FIG. 4 shows the experimental setup for characterizing the device as set out in the Examples.

FIG. 5 shows change of intensity into the intersection for different voltages as a function of time.

FIG. 6 shows the accumulation of cells at different concentration of cells for 50 V and 20 min.

FIG. 7A shows the intensity profile for accumulation followed by lysis when tested with syto 9 and PI at 50 V applied for 8 mins. FIG. 7B shows the intensity profiled when tested at −50 V for 5 min and 200 V for 3 min. FIG. 7C shows the intensity profile when tested at 50 V for 5 min and −300 V for 3 min.

FIGS. 8A-8F show sequential images into the intersection for both excitation markers (for syto 9 and PI) at different time intervals. FIGS. 8A and 8B 50V; FIGS. 8C and 8D 50 V applied for 5 min and 200 V for 3 min, FIGS. 8E and 8F 50 V applied for 5 min and 300 V for 3 min. Each fame indicates the time in seconds and provides a scale bar=40 μm.

FIG. 9A shows the normalized intensity or markers on the nanoporous membrane measured as a function of time at different flow rates for operational voltages of 50V. FIG. 9B shows the normalized intensity or markers on the nanoporous membrane measured as a function of time at different flow rates for operational voltages of 100V.

FIG. 10A is a schematic showing the device configuration for Cross-Flow. FIG. 10B is a schematic showing the device configuration for Co-Flow.

FIG. 11A shows the normalized intensity as a function of time for different electric field directions at an operational voltage of 50 V. FIG. 11B shows the normalized intensity as a function of time for different electric field directions at an operational voltage of 100 V.

FIG. 12 shows characterization of different voltages for the lysis of cells.

FIGS. 13A-13D contain images at intersection after 3 min for different operational voltage when cells are stained with PI. Scale bars are 40 μm.

FIG. 14 shows the lysis efficiency of the device. Mean value and error bars were obtained from multiple runs (3 runs).

FIG. 15 shows the concentration of DNA extracted into the collection channel at different lysis voltages.

FIG. 16 shows one embodiment of the microfluidic device described herein wherein a heating element (a high resistive NiCr heater wire) has been added to the device to facilitate amplification of nucleic acid molecules in the collection channel such as by use of loop mediated isothermal amplification (LAMP).

FIG. 17 shows the amplification intensity of a test sample which contained a DNA molecule of interest and that of a negative control. The intensity of the test sample is higher relative to the negative control and indicating the presence of the DNA of interest in the sample.

FIG. 18 shows one embodiment of a microfluidic device as described herein.

### DETAILED DESCRIPTION

In one aspect, there is provided a method and device for processing cells and/or viral particles in a sample. In one embodiment, the cells and/or viruses are attracted to a nanoporous membrane separating a first microchannel from a second microchannel by an electrophoretic force generated by applying an electric potential across the nanoporous membrane. The nanoporous membrane has pores sized to allow the passage of biomolecules such as nucleic acids but prevents the passage of larger structures such as cells. The cells and/or viruses are then lysed by exposure to an electric field that disrupts the structure of the cell or disrupts the integrity of the virus releasing biomolecules previously associated with the cells or viruses. These biomolecules are then extracted across the nanoporous membrane into the second microchannel.

### Electrical Cell Lysis

Cells can be lysed when exposed to an appropriate external electric field. When such an electric field is applied, the cell membrane acts as a capacitor and a potential difference is established between intercellular and extracellular regions. This difference is known as the transmembrane potential (TMP) and for a spherical cell can be determined from³³:

TMP:∇Ø(t)=FrE cos α(1−exp(−t/tₘ)) (1)

where: r is the radius of the cell, E is the external electric field, tₘ is the charging time of the membrane, F is the cell shape factor and α is the angle between the field line and the normal at the point of interest in the membrane surface.

For many of the cells of interest, the charging time tₘ is on the order of several hundred nano seconds. Hence, for a DC voltage t is much higher than tₘ. So, we can write equation (1) as:

∇Ø(t)≈1.5rE cos α (2)

where F is 1.5 for a spherical cell
For an elongated cell, equation (1) can be written as:

∇Ø(t)≈0.5LE cos α (3)

where F is 0.5 for an elongated cell and L is the characteristic long dimension of the cell and the cell is parallel to E^{34,35}.

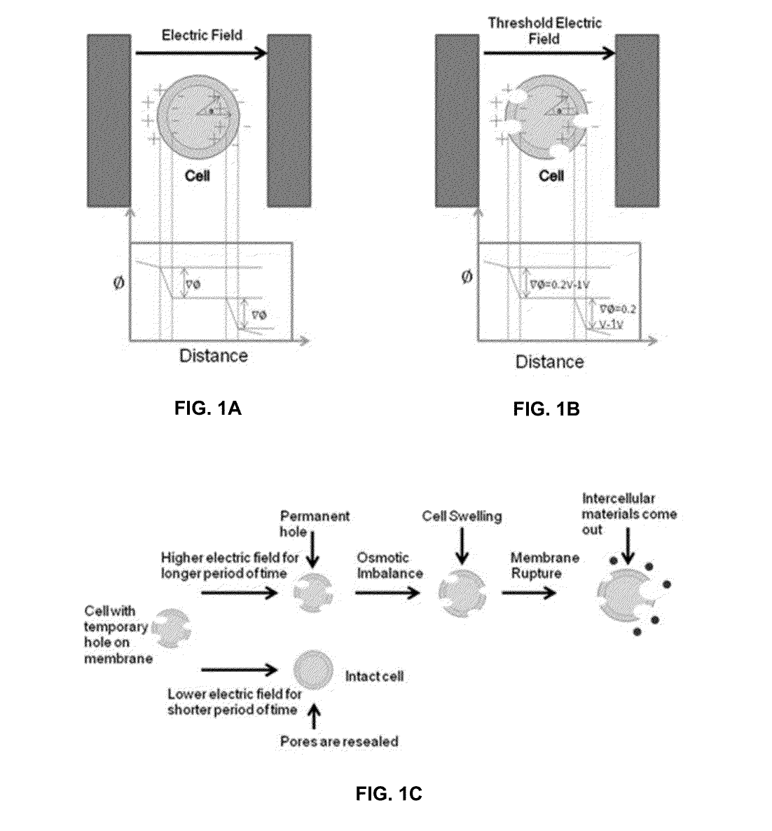

When this potential is about 0.2 to 1 V¹⁵, the cell membrane becomes permeable as small pores are created on its surface. This process is called electroporation. The mechanism of electroporation is not entirely understood. However, the most accepted and widely used model for electroporation based on the electromechanical compression of the cell membrane, as proposed by Zimmermann³⁶, is that the attraction of opposite charges induced on the inner and the outer membrane generates a compressive pressure which makes the membrane thinner and permeable to the medium (FIG. 1A).

Depending on the field strength and duration of the field, these pores might be transient or permanent. If the field strength is low and applied only for a short period of time, then the cell can re-seal itself and this process is known as reversible electroporation. Reversible electroporation is usually used to insert external material such as DNA, RNAi, small molecules or quantum dots into the cells. Irreversible pores can be created by increasing the intensity and exposure to the electric field. This process is known as irreversible electroporation and often results in cell lysis. Initially, the pores formed are small and the cytoplasmic macromolecules are retained inside the cell. However, small ions and water are permeable through those pores. In order to maintain the osmotic balance, water permeates in, the cell swells up, and eventually, cell membrane ruptures³⁷. An exemplary mechanism of electrical cell lysis is shown in FIG. 1. Depending on the size and type of the cells, an electric field strength in the range of 600 V/cm to 2000 V/cm is required to lyse a cell³⁸. In one embodiment, the methods disclosed herein comprise applying an electric potential across a nanoporous membrane in order to generate an electric field strength suitable to lyse one or more cells or disrupt a virus. In one embodiment the electric field strength is in the range of 300 V/cm to 5000 V/cm, 400 V/cm to 4000 V/cm, 400 V/cm to 3000 V/cm, or 600 V/cm to 2000 V/cm.

A skilled person will appreciate that the application of electric field may also be used to disintegrate a virus into viral proteins and nucleic acid molecules associated with the viral proteins. In some embodiments, the methods and devices described herein are therefore useful for processing samples containing one or more viruses and extracting negatively charged nucleic acid molecules from the remaining virus particle.

### Device Design

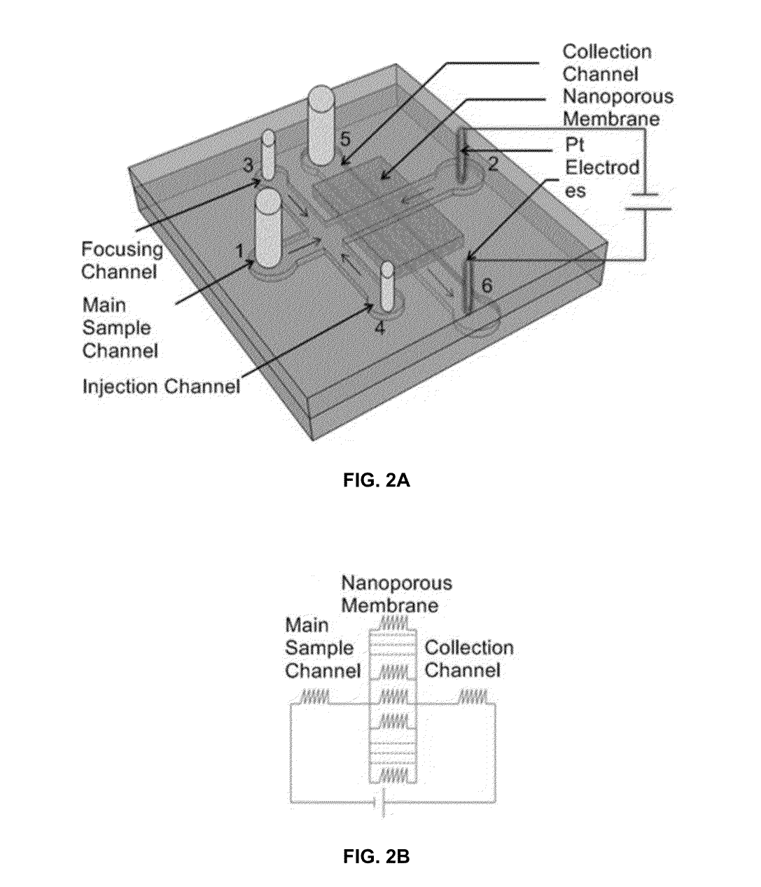

Electrical lysis of the cell or disintegration of viral particles depends on the electric field in the vicinity of the cell or particle as well as the duration of exposure to the electric field. In one aspect, the device includes a nanoporous membrane sandwiched between two microchannels (sample and collection channels) with electrodes embedded in their reservoirs (shown in FIG. 2A. Application of a potential difference between the electrodes in the reservoirs of the sample and collection channels produces a high electric field across the nanopores at the intersection of two channels while the electric field in the microchannels remains low as the nanopores offer high resistance compared to the microchannels. Two side channels, namely the injection and focusing channels, attached to the main sample channel, are used in characterization experiments to inject a controlled volume of sample into the device. Under normal operation, the sample (comprising cells such as bacteria and/or viruses) is flowed in the main sample channel from the injection channel inlet (port 4) and a buffer solutions is flowed from the main sample channel inlet (port 1) and focusing channel inlet (port 3) to the outlet reservoir (port 2). The buffer solution is also flowed from the collection channel inlet (port 5) to its reservoir while the electric field is applied between the electrodes in the reservoirs. In one embodiment, the operation is performed in two steps. In the first step, flow velocity and the applied voltage are optimized to accumulate the cell and/or virus population present in the sample. In the second step, the accumulated cells are electrically lysed and biomolecules such as DNA previously contained within the cells or virus particle are extracted into the collection channel.

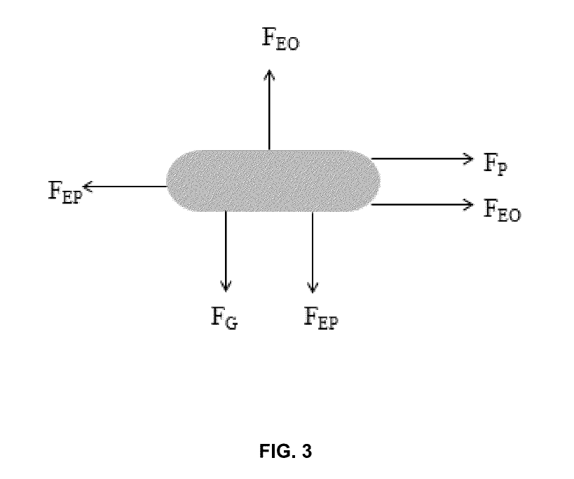

The cells that flow through the main sample channel from the injection channel encounter four kinds of forces namely: drag force due to the pressure driven (Fₚ) and electrosmotic (Fₑₒ) flow, electrophoretic force (Fₑₚ) and gravitational force (F_{g}) on the cells. A free body diagram of forces on an exemplary bacterial cell is shown in FIG. 3.

F_{P}+Fₑₒ=6prh(Uₚ+Uₑₒ) (4)

Fₑₚ=6prhUₑₚ (5)

F_{g}=mg (6)

r is the radius of cell and h is the viscosity of liquid.
U_{P} Pressure driven velocity, Uₑₒ Electroosmotic velocity, Uₑₚ Electrophoretic velocity

Uₑₒ=μₑₒE (7)

Uₑₚ=μₑₚE (8)

μₑₒ=Electroosmotic mobility, μₑₚ=Electrophoretic mobility

The drag force due to the pressure driven flow in the sample channel moves the cell to port 2. In the accumulation step, when the polarity of the potential applied in port 2 is negative, the electrophoretic force on the bacteria is in the opposite direction of the drag force, pulling it towards the nanoporous membrane. As the electric field lines penetrate the nanoporous membrane, the electrophoretic force tends to pin the cell to the membrane surface while the drag force due to the flow tends to sweep it away from the membrane. The electroosmotic flow in typical operating conditions is small compared to the pressure drive flow and can be ignored. Under suitable flow rate and applied potential, the electrophoretic force can be greater than that the drag force and the cell population in the sample accumulates onto a confined area on the nanoporous membrane.

The device design and operating conditions can be optimized such that the cell population is accumulated on to the membrane while at the same time maintaining the localized electric field at the nanopores lower than the critical electric field for lysis of the cells. In the lysis (second) step, the pressure driven flows from the injection and focusing channels may be stopped or slowed while the voltage is increased such that the local electric field in the vicinity of the nanopores is above the critical electric field for lysis to occur. Since the resistance of the microchannel is lower than that of the nanopore, its electric field is lower. This leads to lysis of the cells that have accumulated on the nanoporous membrane and the extraction of negatively charged biomolecules such as DNA or other analytes through the nanopore into the collection channel. Since many thousands of pores exist at the intersection between the two microchannels, the several thousands of the accumulated cells can be lysed.

A skilled person will appreciate that different dimensions and/or operating conditions may be selected for the microdfluidic device described herein in order to ensure operation of the method and device and the collection and lysis of cells or viruses.

For example, in one embodiment of the device described and demonstrated in Example 1, the height of all microfluidic channels was set as 50 μm. The widths of the first microchannel (main sample channel) and second microchannel (collection channel) were set as 80 μm, while those of the focusing and injection channels connected to the main sample channel were set as 40 μm. These dimensions were chosen based on optimization of the electrical resistances of these channels and the membrane, as well as the fabrication constraints to ensure that a significant proportion of the overall potential drops across the membrane. For instance, if the widths of main sample and collection channels are larger, then the number of pores in the intersection will be higher and the total resistance of the membrane will be lower. This will require a higher potential to be applied for lysis. However, if the width is very small, the resistance of the main sample channel will increase, leading to cell lysis in that channel. Similarly, the distance of the intersection from the waste and collection reservoirs is another important parameter to be optimized. If this distance is longer, the resistance of the main sample channel will be higher. However, reducing the distance also reduces the time available for the electrophoretic force to counter the drag force and accumulate the bacteria on the membrane. In addition, consideration of the operational and characterization difficulties led to a length of the sample microchannel of 4 mm. In one embodiment, the height of the microfluidic channels may be between 1 μm and 1000 μm and the width of the microfluidic channels may be between 1 μm and 1000 μm.

In one embodiment, a nanoporous membrane separates the first microchannel and the second microchannel. In one embodiment, the nanoporous membrane serves to allow for the passage of biomolecules between the first microchannel and the second microchannel and blocks the passage of cells or larger particles from the first microchannel to the second microchannel.

The nanoporous membrane may be made out of various materials known in the art. For example, in one embodiment, the nanoporous membrane is made of polycarbonate, polyester, polyethersoulfone, glass, silicon, silicon dioxide, silicon nitride, polystyrene, rubber or a combination thereof. The nanoporous membrane may also be coated to improve the properties of the membrane such as to increase hydrophilicity of the membrane.

For example, in a preferred embodiment the nanoporous membrane is a polyvinylpyrrolidone (PVP) coated polycarbonate nanoporous membrane. These membranes have a single pore size, are thin and easy to integrate with PDMS compared to other membranes. Polyvinylpyrrolidone (PVP) coating is used to render them hydrophilic which help the sample solution to wet the membrane and make electrical contact through the membrane. In addition, the PVP coating is suitable for minimizing the electroosmotic flow³⁹. PVP membranes with various pore sizes are commercially available and their pore density varies with pore size. Table 1 shows the various commercially available pore sizes and corresponding pore densities and thicknesses of the membranes. Since in the exemplary embodiment described and tested in Example 1 the area of the membrane at the intersection between the sample and collection channel is 80×80 μm², the voltages that must be applied to obtain a critical electric field of 1600 V/cm across the nanopores to lyse bacteria³¹ can be calculated for various membrane specifications as shown in Table 1.

TABLE 1
The relationship between pore sizes and operational voltage
necessary to generate a potential difference suitable for cell lysing.

| | | | Number of pores | |
|---|---|---|---|---|
| | | Thickness | into the | Required Voltage |
| Pore | | of the | intersection of | (Approx) to |
| Size | Pore Density | membrane | 80 × 80 μm² | generate |
| (μm) | (pore/cm²) | (μm) | intersection | 1600 V/cm (V) |
| 5 | 4 × 10⁵ | 10 | 26 | 165 |
| 1 | 2 × 10⁷ | 11 | 1280 | 325 |
| 0.4 | 1 × 10⁸ | 10 | 6400 | 260 |
| 0.2 | 3 × 10⁸ | 10 | 19200 | 195 |
| 0.1 | 4 × 10⁸ | 6 | 25600 | 66 |
| 0.08 | 4 × 10⁸ | 6 | 25600 | 35 |

From Table 1, it is apparent that the critical electric field for lysis can be generated at the nanopores of 0.08 μm and 0.1 μm pore size membranes by applying just 35 and 66 V, respectively. Similarly, suitable electric potentials for generating electric fields sufficient to attract cells or to lyse cells using a different nanoporous membrane may be determined by a person of skill in the art.

In some embodiments, different pore sizes may be selected based on the types of cells in the sample and the biomolecules to be extracted across the membrane. For example, any pore size greater than 0.5 μm will not be able to retain E. coli as its size is 0.5 μm in diameter and 2 μm in length. On the other end, any pore size smaller than 0.2 μm may present fabrication and operational problems as priming the pores to form electrical and fluidic interconnections between the sample and the collection channel become difficult. In one embodiment, the pores have a diameter between about 1 nm and 5 μm or between about 1 nm and 1 μm. In one embodiment, the pores have a diameter less than about 1 μm, less than about 0.5 μm, less than about 0.1 μm, or less than about 100 nm. In one embodiment, the pores have a diameter between about 50 nm and 1 μm. In one embodiment, the pores have a diameter between about 0.1 μm and 1.0 μm, between about 0.5 μm and 0.25 μm or between about 0.4 μm and 0.2 μm. In one embodiment, the pores have a diameter of about 0.4 μm. In one embodiment, the cells are bacterial cells such as E. Coli, and the pore diameter is about 0.4 μm.

The size of the surface area of the nanoporous membrane separating the first microchannel and the second microchannel may also be adjusted depending on the manufacture and operation of the device or method as described herein. In one embodiment, the surface area of the nanoporous membrane separating the between about 100 um² and 100,000 um², between about 500 um² and 50,000 um² or between about 1000 um² and 10,000 um². Optionally the surface area of the nanoporous membrane in a device or in a series of devices may be increased in order to increase the volume of sample that can be processed.

The microfluidic device described herein may be constructed using techniques known in the art of microdevices such as lithography. For example, in one embodiment the microchannels may be made of polydimethyl siloxane (PDMS), polystyrene, polycarbonate, silicon, glass, polyester, rubber, polyethylene, epoxy, or polyurethane or a combination thereof.

In one embodiment, a first electrical potential is applied across a nanoporous membrane in order to generate an electrophoretic force and attract cells in the first microchannel to the nanoporous membrane. In one embodiment, the electric potential is selected such as to attract the cells without lysing the cells. In one embodiment the first electric potential results in an electric field in the nanopores of at least 100 V/cm, at least 250 V/cm, at least 300 V/cm, at least 350 V/cm, or between about 250 V/cm and 500 V/cm. In one embodiment, the voltage applied to electrodes in the first and second microchannels to attract the cells to the nanoporous membrane is between about 50V and 100V.

In another embodiment a second electrical potential is applied across the nanoporous membrane in order to lyse the cells. In one embodiment, the second electric potential results in an electric field in the nanopores of at least 500 V/cm, at least 600 V/cm, at least 750 V/cm, at least 1000 V/cm, at least 1500V/cm at least 1750 V/cm or at least 2000 V/cm. In one embodiment, the second electric potential results in an electric field in the nanopores of between 600 V/cm and 5000 V/cm, between 600 V/cm and 3000 V/cm or between 600 V/cm and 2000 V/cm. In one embodiment the voltage applied to electrodes in the first microchannel and second microchannel to lyse the cells is between about 100 V to 300 V.

In one embodiment, the methods described herein include controlling the flow rate of a sample comprising one or more cells past the nanoporous membrane in the first microchannel. In one embodiment, the flow rate is less than about 200 ul/hr, less than about 175 ul/hr, less than about 150 ul/hr, less than about 125 ul/hr, less than about 100 ul/hr or less than about 75 ul/hr. In one embodiment, the flow rate is between about 75 and 125 ul/hr and the first electric potential results in an electric field in the nanopores of between about 250 V/cm and 500 V/cm.

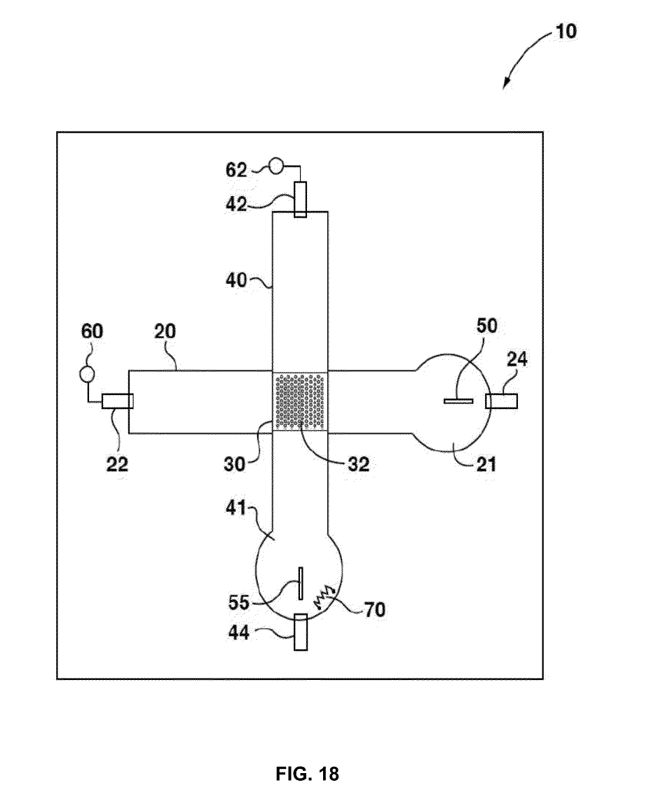

Turning to FIG. 18, there is shown a microfluidic device (10) comprising a first microchannel (20), a second microchannel (40) and a nanoporous membrane (30) separating the first microchannel from the second microchannel. The nanoporous membrane has a plurality of pores (32) that allow for the passage of biomolecules between the first microchannel (20) and second microchannel (40). A first electrode (50) is positioned within the first microchannel and a second electrode (55) is positioned within the second microchannel for applying an electric current across the nanoporous membrane (30). The first (50) and second (55) electrodes may be positioned near the nanoporous membrane (30), or away from the nanoporous membrane along the first and second microchannels. In one embodiment, the first microchannel (20) includes one or more reservoirs (21) and the second microchannel (40) includes one or more reservoirs (41). Optionally, the first (50) and second (55) electrodes are positioned away from the nanoporous membrane in the first microchannel reservoir (21) and second microchannel reservoir (41).

In one embodiment, the first microchannel has a sample inlet (22) and a sample outlet (24) positioned on either side of the nanoporous membrane (30). Optionally, a pump (60) is connected to the sample inlet for controlling the flow of sample from the sample inlet (22) to the sample outlet (24).

In one embodiment, the second microchannel (40) has an inlet (42) and an outlet (44) on either side of the nanoporous membrane (30). Optionally, a second pump (62) may be connected to the inlet (42) for controlling the flow of a collection stream past the nanoporous membrane (30).

In one embodiment, the microfluidic device includes a heating element (70) useful for heating all or part of the second microchannel (40). For example, in some embodiments reagents suitable for conducting a PCR reaction are contained within the second microchannel and the heating element is used to amplify nucleic acid molecules that have been extracted into the second microchannel.

### Example 1

### Fabrication and Testing of a Microfluidic Device

### Fabrication of a Microfluidic Device

An exemplary microfluidic device was constructed in two layers. Microchannels in the top and bottom layers were fabricated in PDMS by using a rapid prototype and soft lithography process⁴⁰. The mask layout was designed in AutoCAD™ (Autodesk Inc., San Francisco, USA) and printed using ultra high-resolution laser photoplotting on a transparency sheet. SU8-2075 (50 mm thick) negative photoresist (MicroChem Corp., MA, USA) was used to lithographically pattern a master mold of the top and bottom layers of the device. Polydimethylsiloxane (PDMS) pre-polymer mixture (Sylgard™ 184 kit, Dow Corning Corp., MI, USA; 10:1 ratio of the base and crosslinker) was cast on the master mold, and then cured at room temperature for 24 h. Next the PDMS replica was peeled off the master mold and cut into pieces containing individual channels. The inlet and outlet access ports were punched out at the reservoir areas for the top layer. Polycarbonate membrane coated with polyvinylpirodyne (PVP) was obtained from Sterlitech Corporation, USA. The membrane was cut with a section of 3 mm×3 mm. In order to attach a nanoporous membrane on the microchannel, a thin layer of PDMS was obtained by spinning PDMS pre-polymer (base/curing agent: 1/3) on the silicon wafer at 8000 rpm for 2 min. The microchannel top surfaces which was used for the bottom layer was placed on the thin uniform PDMS pre-polymer and lifted off. Next, the membrane was placed on the middle of the bottom layer. Then, the top surface of top layer was placed on the thin uniform PDMS pre-polymer and lifted off. The PDMS piece with membrane attached was then aligned and bonded with the top layer PDMS piece. Finally, whole device was kept at room temperature for overnight (˜16 hr) and then cured at 120° C. for 1 hr. Inlet reservoirs were connected to a thin tube where metal electrodes (Pt wire, 0.25 mm in diameter) were inserted to outlet reservoirs of both channel.

### Experimental Setup and Procedures

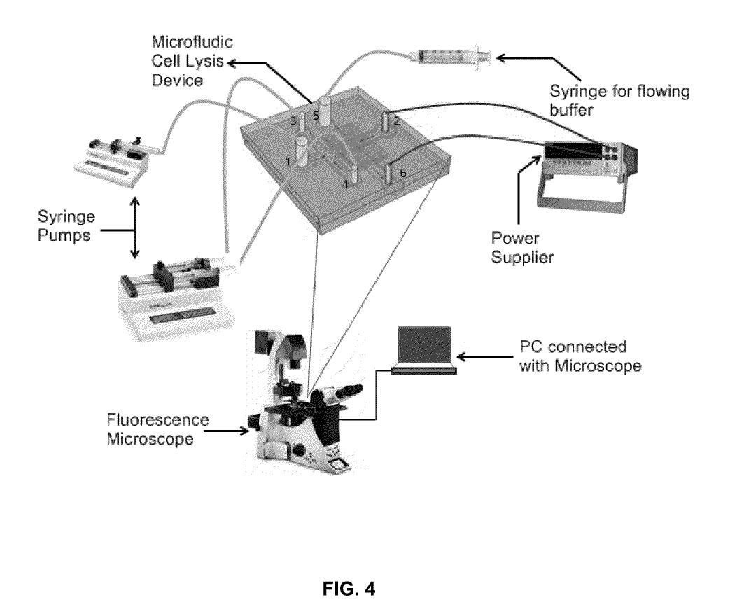

The experimental setup shown in FIG. 4 that was used to study the accumulation of bacteria and lysis consists of four major parts: the microfluidic device, the bacteria and buffer handling system (syringe pumps, syringe, and inlet-outlet connection), power system (power supply and electrodes) and a monitoring unit (microscope and PC).

E. coli and a bacteria viability kit with the fluorescent dyes Syto 9 and PI were used to demonstrate the attraction and accumulation of cells to the membrane in the microfluidic device. Syto 9 can permeate the intact membrane of bacterial cells, binds with nucleic acid and forms a green-fluorescent complex. In contrast, propidium iodide (PI) cannot permeate the intact membrane, but it can permeate damaged membranes and binds to nucleic acid forming a red-fluorescent complex. By using an appropriate mixture of these two dyes, the intact cells can be stained to be green-fluorescent while cells with damaged membrane can be stained to be red fluorescent. Since, these dyes have been used during preparation of sample, intact bacteria fluoresce green (500-550 nm) when excited with blue light (488 nm) and lysed bacteria fluoresce red (595-660 nm) when excited with green light (561 nm).

First, the sample and the collection channels were loaded with phosphate buffer and platinum wires (diameter 0.3 mm) were inserted into the reservoirs 2 and 6 (FIG. 4). Electrodes were connected to a power source (KEITHLEY 2410). The membrane was first primed by applying 100 V and the current was recorded. Next, any trapped air bubbles were removed by flowing buffer from reservoirs 3 and 5 by a syringe. Reservoirs 3 (buffer) and 4 (bacteria) were connected to syringe pumps with the same flow rate (KD Scientific 200) and reservoir 1 was connected with another syringe pump whose flow rate can be set independently (KD Scientific 100). Next, all pumps were started with a flow rate of 100 μl/hr. A syringe was used to flow buffer in the bottom channel manually through reservoir 5. When bacterial cells were observed to approach the membrane region in the top channel, a potential (50 V) was applied at the electrodes and images were captured at emission frequencies of the dyes using appropriate filters cube (described below in fluorescence microscopy). Images were taken every 5 sec to obtain data on cell accumulation. After applying 50 V for 3 min, the flow in the side channels with bacteria was stopped and the flow rate of buffer was increased to 200 μl/hr. This condition was used for 2 min. This operation resulted in the flow of a fixed amount of bacteria (required for characterization) across the membrane region. At the end, the operational voltage was increased for another 3 min to lyse the accumulated cell population.

### Bacterial Sample Preparation

K-12 E. coli strain derivative (MG1655) and E. coli expressing Green Fluorescence Protein (GFP) (MG1655) were used for different experiments. E. coli was inoculated by adding a single colony from pre-made bacteria agar plate to 4 ml of the freshly prepared Luria Broth (LB). In case of E. coli expressing GFP, kanamycin (50 μg/ml) was used in the medium. The culture was incubated in a shaker bath for 16 hr at 37° C. The concentration of bacteria was around 10⁸-10⁹ Colony Forming Units (CFU)/ml after harvesting⁴¹.

Subsequently, 1 ml of culture was transferred to a microcentrifuge tube and centrifuged at 7000 rpm for 7 min. The supernatant was removed by using a pipette and the resulting pellet was washed by using phosphate buffer (pH 7) 3 or 4 times. Serial dilution was done afterwards to obtain a cell concentration of about 10⁶-10⁷ CFU/ml.

1.5 μl of SYTO 9 and 1.5 μl of PI were added to each sample when E. coli strain K-12 (MG1655) without GFP was used and incubated for 30 min in a dark environment.

### Fluorescence Microscopy

A fluorescence microscope was used to monitor all experiments. Two different kinds of fluorescence microscopes, namely Widefield Deconvolution and LumaScope™, were used. Widefield Deconvolution (Leica™ DMI 6000 B) was used in experiments that required simultaneous imaging of SYTO 9 and propidium. The images were taken using a CCD camera (Hamamatsu Orca ER-AG). LumaScope (LS-500: BF/FL, BIOIMAGER) was used to image accumulation of GFP expressing bacterial cells.

### Plate Counts

The conventional method that is commonly used to check viability and to count the number of cells is the plate counting method. This is a standard method and colonies of bacteria are formed in agar plate. If the bacteria are dead, no colonies form. Thus, we used this method to find out the efficiency of the device. Cell suspensions were diluted with phosphate buffer (pH 7.0) and 100 μl portion of appropriate dilution was spread out in a premade agar plate. After incubation overnight at 37° C., the colonies from plates were counted.

### Results and Discussion

The operation of the device consisted of two stages: 1) electrophoretic accumulation and 2) electrical lysis. These were controlled by the setting the applied voltage so that the local electric field close to the pores of the membrane are below the critical threshold for lysis in the case of accumulation and above threshold in the case of lysis.

### Electrophoretic Accumulation

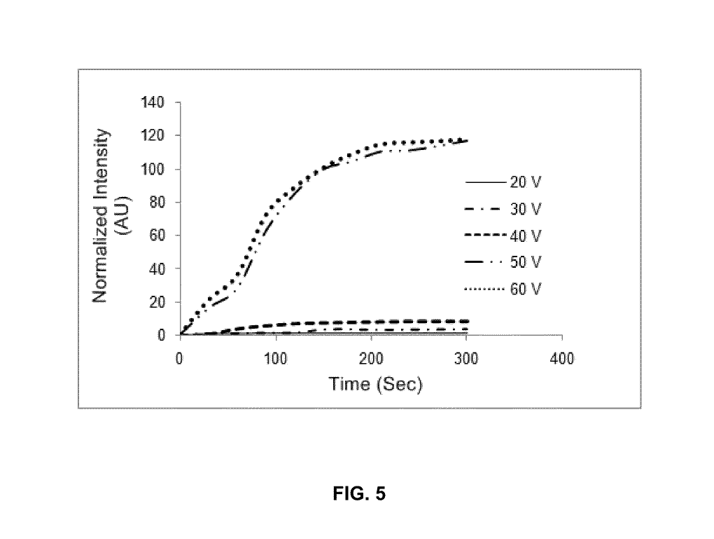

Experiments were conducted to determine the minimum threshold voltage required to accumulate the cells at the nanoporous membrane interface. A flow of 100 μl/hr of sample (buffer with concentration of 10⁶-10⁷ CFU/ml of E. coli) in the injection channel and 100 μl/hr of buffer in the focusing and sample channel was maintained for 5 min. The flow in the focusing and sample channels were used here so that the injected sample volume can be accurately controlled for all the experiments. The cell suspension was stained with Syto 9. Voltages from 20 V to 60 V were applied for the entire duration (5 min) when the sample flow was on. The electric field due to the applied voltage was present in the section of the sample channel downstream from the membrane and was in the direction such that it imposed an electrophoretic force on the negatively charged bacteria to move towards the membrane. Fluorescent images of the nanoporous membrane at the intersection of the two channels were taken every 5 sec with blue excitation. Results are shown in FIG. 5. The fluorescent intensity in the images was quantified using ImageJ software (from NIH).

As shown in FIG. 5 the fluorescent intensity at the membrane increased significantly and becomes saturated when the applied voltage is above 50V. Also, the intensity does not increase with time when the applied voltage is below 50V. This observation is expected as movement and accumulation of bacteria in the flowing sample is due to a combination of the electrophoretic force on it pulling it onto the membrane and the drag force of the fluid pulling it towards the outlet. When the applied voltage is lower than 50V, the electrophoretic force on the bacteria due to the electric field in the channels is not sufficiently high to overcome the drag force of the fluid, which prevents accumulation. As the applied voltage is increased, the electrophoretic force increases while the drag force remains constant. At 50 V the electrophoretic force is strong enough to overcome the drag force and pull the bacteria from the sample onto the membrane. The bacteria rapidly accumulate on the membrane pores until all pores are blocked. Once the pores are blocked, the electric field in the sample channel falls and no more net accumulation takes place. The rate of accumulation and the amount of saturation remains steady even when the applied voltage is increased from 50 V and 60 V as the volumetric flow rate of the bacteria across the membrane is the same irrespective of the applied potential and therefore, the rate of accumulation will be similar once the threshold voltage for accumulation has been achieved.

### Effect of Sample Concentration on Accumulation of Cells

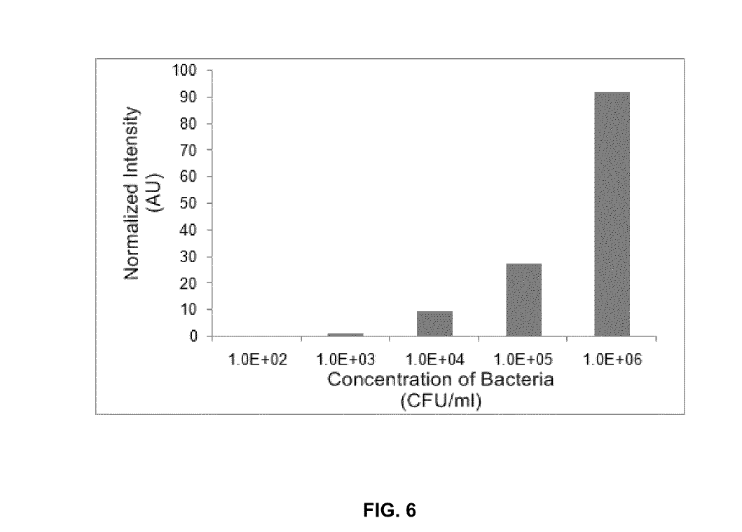

The purpose of the accumulation step becomes important when the bacterial concentration is low. In order to demonstrate accumulation under various sample concentrations, sample solutions containing GFP expressing E. coli at concentrations ranging from ˜10²-10⁶ CFU/ml were tested. The flow conditions were similar to the previous experiment with a sample flow rate of 100 μl/hr. A voltage of 50 V was applied for 20 min and images of the nanoporous membrane at the intersection of two channels were taken every 30 sec. The intensity of the accumulated bacteria (FIG. 6) show a steep increase with sample concentration.

Significant accumulation was obtained for sample concentrations between 10⁴-10⁶ CFU/ml within 20 min. The accumulated concentration was much lower when the sample concentration was 10³ CFU/ml. This is as expected as at the set flow rate and duration, only ˜20 bacteria would have flowed past the accumulation region at a sample concentration of 10³ CFU/ml. In the case of 10² CFU/ml only ˜2 bacteria would be present and it did not show any measureable intensity variation under the conditions studied.

### Electrical Lysis

Once the threshold voltage (50 V) for accumulation was determined experiments were conducted to determine whether the accumulated cells can be lysed. In this experiment an E. coli sample (concentration of 10⁶-10⁷ CFU/ml) stained with Syto 9 and PI was introduced in the injection channel and buffer was introduced from the focusing and sample channels (FIG. 2A) with a flow rate of 100 μl/hr. A voltage of 50 V was applied for 8 min and images of the nanoporous membrane at the intersection of two channels were taken every 5 sec for blue and green excitations.

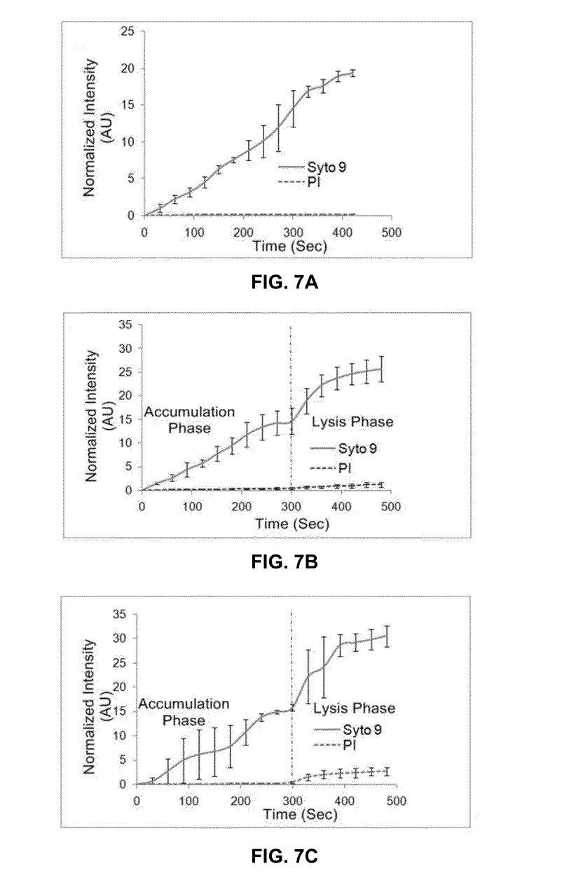

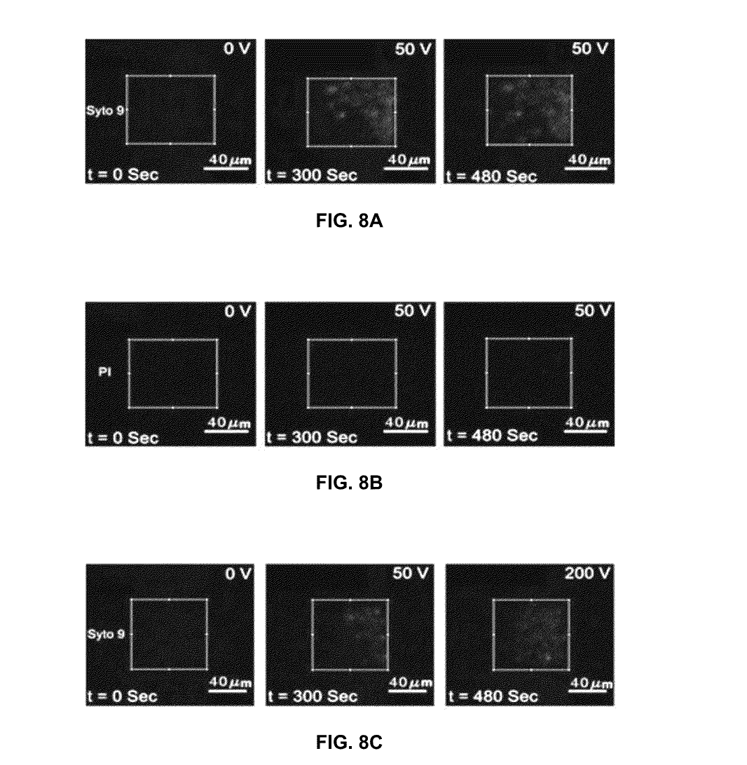

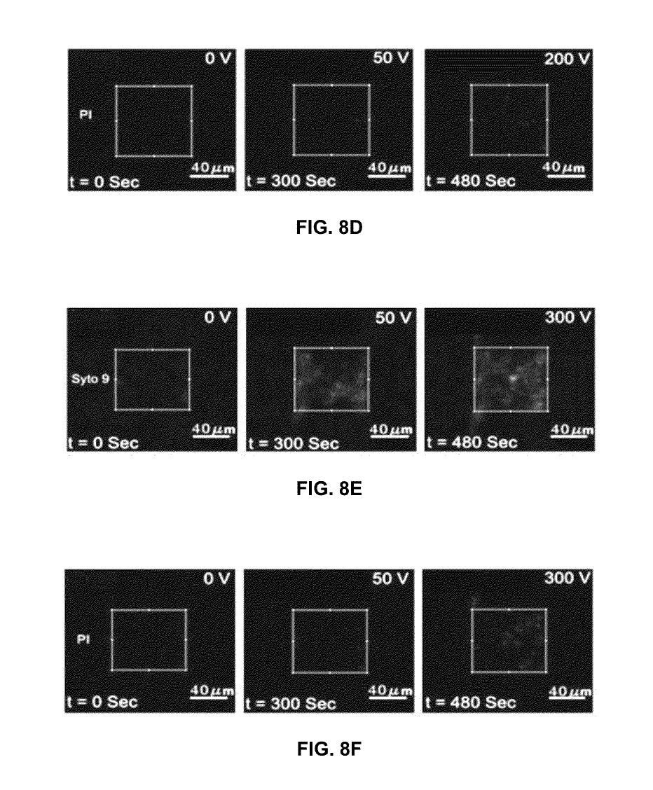

The intensity of fluorescence from Syto 9 and PI over 8 min of accumulation at 50V is shown in FIG. 7A. Images of the nanoporous membrane interface for Syto 9 and PI at various time points during accumulation (t=0, t=300 & t=480 s) during application of 50 V are shown in FIG. 8A and FIG. 8B. These results show that a rapid increase in the Syto 9 intensity over time whiles the intensity of PI did not increase indicating that the accumulating bacteria are intact and not lysed. At the applied voltage of 50 V, the electric field in the nanopores was 308 V/cm and in the main sample channel was 62.11 V/cm, both of which are well below the critical electric field required to lyse the cell.

After confirming accumulation of intact cells, experiments were conducted to demonstrate cell lysis using higher voltages as described in the section titled Experimental Setup and Procedures. In these experiments, accumulation was done for 5 min using a procedure similar to the one previously described herein. Subsequently, the flow in the injection channel was stopped and the flow in the sample and the buffer channels were continued in order to flush away the remaining sample solution in the upstream region. Then the applied potential was increased to 200 V and 300 V which corresponds to local electric field at the nanopores of 1230 V/cm and 1860 V/cm respectively.

The intensity profile of both Syto 9 and PI at the membrane interface as presented in FIG. 7B shows rapid accumulation of bacteria till 5 min when steady state is reached. Subsequently, when the higher voltage is applied at 300 sec, there was a rapid increase in the intensity of both Syto 9 and PI that also subsequently saturated with time. This behavior is as expected. A continuous flow of cell for the first 3 min led to the gradual increase in accumulation of the bacteria which is indicated by the increase in the intensity of SYTO 9.

Subsequently, the flow of the sample was stopped and only the buffer flow was maintained in the next 2 min, leading to a steady state in the amount of bacteria accumulated. This procedure was done in order to precisely define the amount of bacteria injected into the device. During 5 min the intensity of PI did not increase indicating that bacterial lysis did not occur.

Subsequently, when the applied potential was increased to 200 V and applied for 3 min the cells lysed leading to a sharp increase in fluorescence intensity of Syto 9 (FIG. 8C). These are attributed to the higher permeability of the lysed membrane as compared to the intact membrane to Syto 9. More significantly, the intensity of the PI (FIG. 8D) also increased, providing a clear indication that the cells are lysed at this applied potential. The electric field calculated at the nanopores was 1230 V/cm at an applied potential of 200 V which was higher than the threshold for lysis. No lysis was observed in the microchannels as the electric field was around 250 V/cm and well below the threshold. A similar trend in the fluorescence intensities for Syto 9 and propidium iodide was also observed when 300 V (FIG. 8E and FIG. 8F) was applied during the lysis phase after accumulation at 50 V for 5 min.

### Effect of Flow Rate

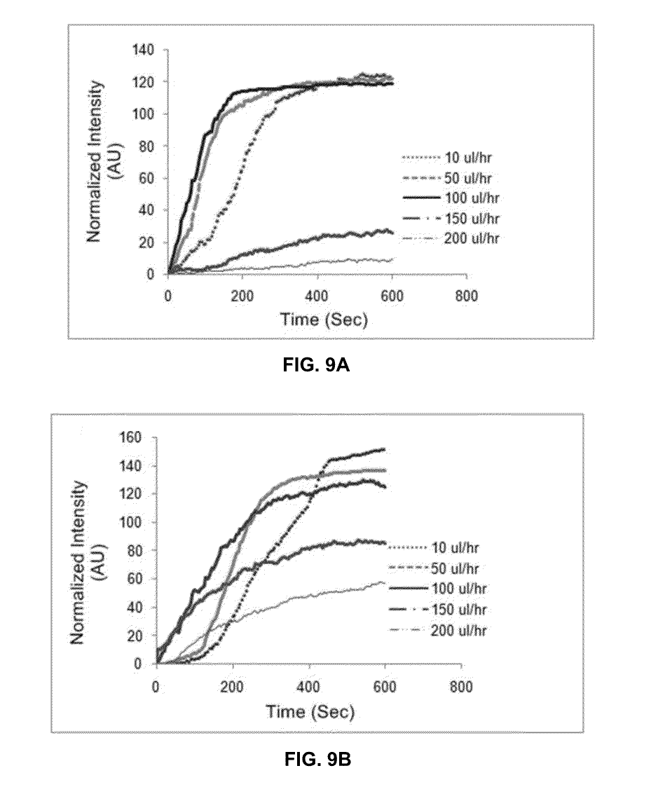

Determination of the influence of flow rate on the collection efficiency during the accumulation phase is important for the efficient functioning of the device. The drag force imposed by pressure driven flow moves the bacteria away from the membrane and therefore its balance with the electrophoretic force will determine the efficiency of accumulation on the membrane. A high flow rate is desirable in order to process a large volume of sample. However, high flow rates will require higher applied voltage in order to overcome the drag force and accumulate the bacteria from the sample onto the membrane. The applied voltage cannot be increased beyond the point where the threshold electric fields are reached either at the nanopores, or more importantly, at the channel as it would lyse the bacteria. Therefore, experiments were conducted in order to determine the optimal flow rates to operate this device in the accumulation mode at applied voltages of 50 V and 100 V (below the threshold for lysis). E. coli expressing GFP with a concentration of 10⁶-10⁷ CFU/ml was used for this experiment and the set-up was same as discussed in above. The experiment was conducted for 10 min with the sample and buffer flowing for the entire experiment. Five different flow rates (10 μl/hr, 50 μl/hr, 100 μl/hr, 150 μl/hr, and 200 μl/hr) were used. The results are shown in FIG. 9A and FIG. 9B for an operational voltage of 50 V and 100 V respectively.

In the case of the applied voltage of 50 V (FIG. 9A), the bacteria accumulate on the membrane at flow rates below 150 μl/hr when the electrophoretic force is able to overcome the drag force and the accumulation is significantly reduced above it. The rate of accumulation at low flow rates was also found to increase with the flow rate. This is as expected since the amount of bacteria passing the membrane is higher for higher flow rates. Finally, it can be seen that the accumulation saturates the membrane after a certain time and equilibrium is reached.

In the case of 100 V applied voltage (FIG. 9B), the distinction between high and low flow rates are not as dramatic. Since the electrophoretic force is stronger, bacteria accumulate on the membrane even at high flow rates. However, the total accumulated amount at equilibrium is found to be inversely proportional to the flow rate. The trend for the rate of accumulation was similar to the one observed at 50 V. From these experiments, it was concluded that 100 μl/hr was the optimal flow rate for rapidly accumulating the cells at the nanoporous interface.

### Characterization of Co-Flow and Cross-Flow

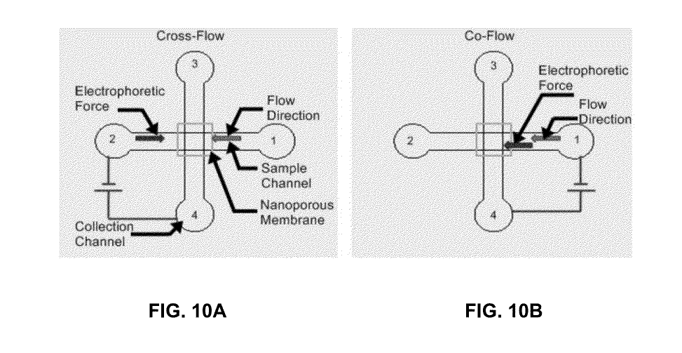

Various configurations of flow can be used in the accumulation device. The flow of the sample and the direction of the electric field could be the same (co-flow) or opposite (cross-flow) to the pressure driven flow in the main sample channel. It is expected that when the device is operated in the cross-flow configuration the cells have a higher residence time above the nanoporous interface and therefore are likely to accumulate more as compared to the co-flow configuration. The devices used for characterizing the effect of flow configurations are shown in (FIG. 10). Similar to the previous devices, it consists of two channels—a sample (top) and a collection (bottom) channels with a nanoporous polycarbonate membrane sandwiched between them.

In both the configurations, the sample (10⁶-10⁷ CFU/ml) was flowed from reservoir 1 and buffer from reservoir 3 with a flow rate of 100 μl/hr and the applied voltage was 50 V and 100 V. The dimensions of the device were such that the intensity of the electric field was the same in both the configurations while the direction changed. Accumulation of bacteria was compared by measuring the intensity of GFP from GFP expressing E. coli at the intersection for both setups over a duration of 5 min.

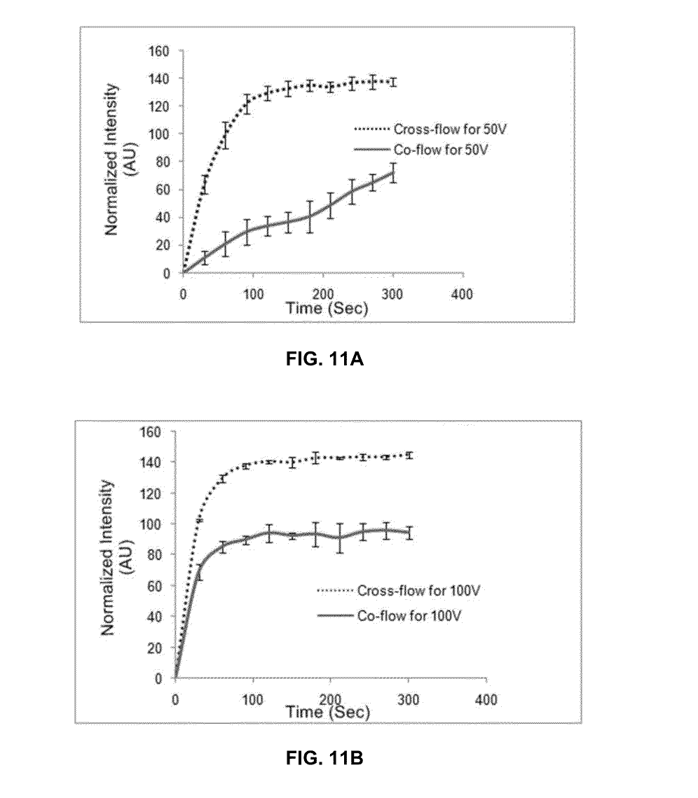

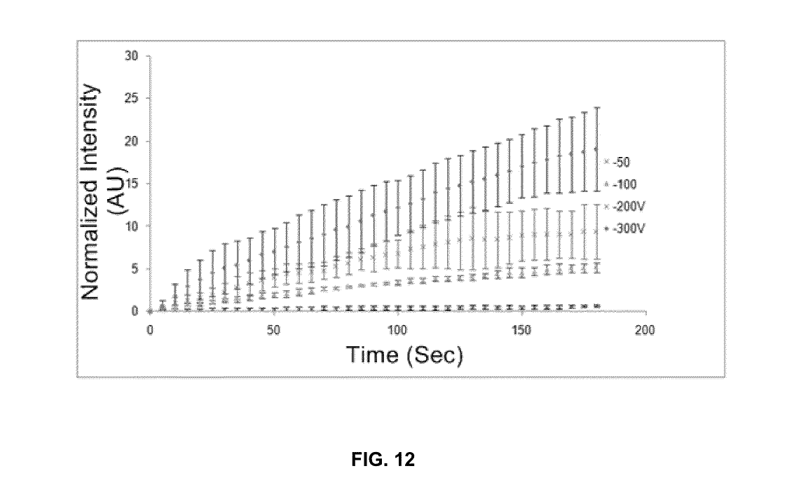

As seen in FIG. 11, the accumulation in the cross flow configuration is higher and faster than that for co-flow configuration at both the accumulating voltages as expected. At 100 V a larger amount of bacteria can be accumulated as compared to 50 V in the co-flow configuration due to higher electrophoretic force on the bacteria which increases its residence time in the channel.

### Effect of Voltage

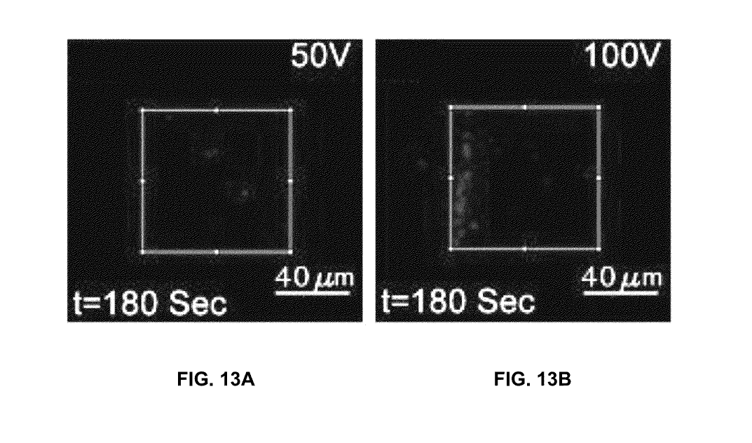

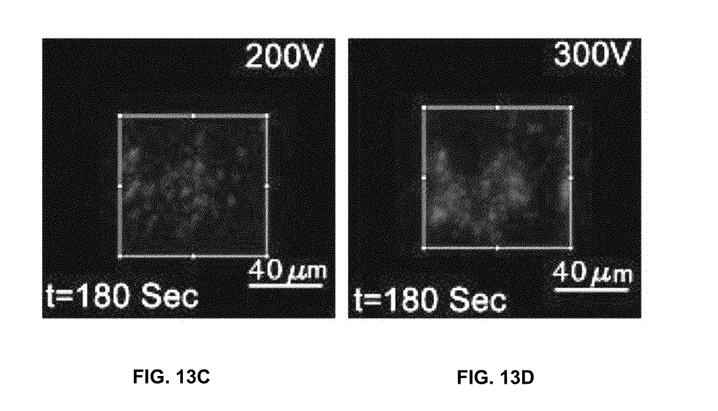

The applied voltage and the resultant electric field at the nanopores is the most important parameter determining the efficiency of the lysis process. In order to determine the effect of voltage, samples of E. coli (10⁶-10⁷ bacterial cells/ml) were incubated with PI for 30 min and exposed to applied voltages of 50 V, 100 V, 200 V, and 300 V for a duration of 3 min while flowing at 10 μl/hr in a cross-flow configuration. It should be noted that in this configuration, the cells are simultaneously captured on the membrane and lysed immediately. The intensity of the PI at the nanoporous membrane which is indicative of cell lysis is plotted in FIG. 12 for various applied voltages. Images of the membrane interface at various applied voltages at the same instance of time are shown in FIG. 13.

It can be seen in FIG. 13A that lysis is minimal at 50 V applied voltage, as the Electric field (308 V/cm) at the nanoporous interface was much lower than the threshold value for lysis. When the voltage was increased to 100 V (electric field of 616 V/cm) some of the cells lyse (FIG. 13B). It has been reported that cell lysis starts at 600 V/cm for Chinese hamster ovary (CHO) cells⁴² and that the lysis also depends upon the duration of field³⁸. Although bacteria were used here which was quite small compared to CHO cells, the exposure time was much higher. The higher exposure time close to the threshold for lysis could have led to the lysis of some cells at low efficiency. When the applied voltage was increased to 200 V (electric field 1232 V/cm) or 300 V, a significant increase in fluorescence intensity of PI was observed at the nanoporous interface (FIG. 13C, FIG. 13D) indicating significant increase in cell lysis. At 300 V, where the electric field was around 1860 V/cm, the entire interface was saturated by red fluorescence and cells were completely disintegrated. It can be concluded that increasing the voltage leads to higher capture and lysis of bacteria from the sample.

### Lysis Efficiency and Collection of DNA

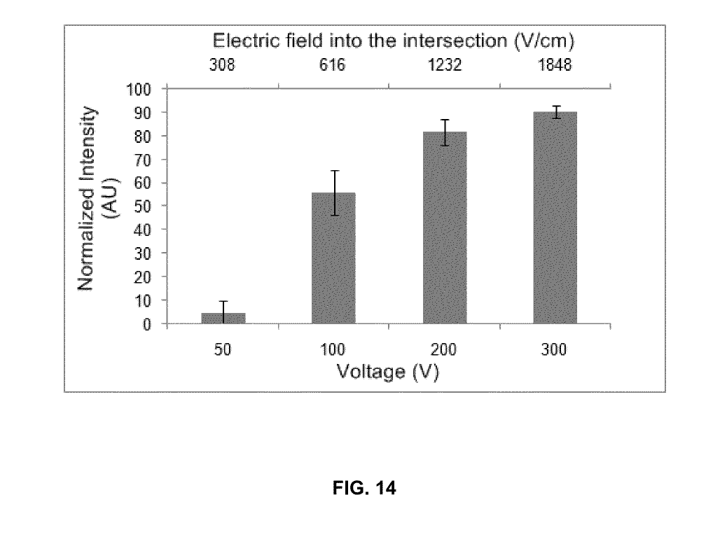

Plate counting was done to determine the lysis efficiency of the device at various applied voltages. After running the test as mentioned in the previous section, 10 μl of solution was collected from sample channel and collection channel outlet. After collection, the sample was diluted and plated on an agar plate. First, the test was run by applying zero voltage which was used as control. Efficiency was then calculated by comparing to this control. The results are shown in FIG. 14.

As shown in FIG. 14, the efficiency of lysis increases with the applied voltage. It is 56% at 100 V, 82% at 200 V (1232 V/cm) and 90% at 300 V (1860 V/cm) while only 5% were lysed at 50 V. This result confirms and quantifies the trend observed using fluorescence measurements. Also, no colonies were formed from the fluid collected from the collection channel confirming that intact bacteria did not pass through the membrane.

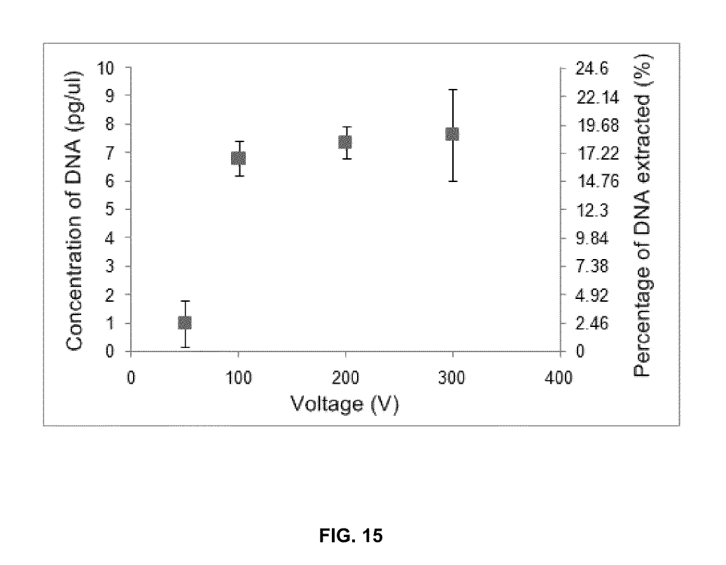

To confirm and quantify the genomic DNA after lysis, qRT-PCR was also performed. E. coli with a concentration of 10⁸ CFU/ml was flowed from the injection channel at a flow rate of 100 μl/hr and buffer was supplied from main and focusing channels with same flow rate. After running the test for 5 min, the sample was collected from the collection channel and qRT-PCR analysis was performed using a pair of primers targeting E. coli DNA. It can be seen from FIG. 15 that the amount of DNA collected in the collection channel is significantly higher when the applied voltage is higher than 100 V. In addition, we calculated the total weight of DNA that is present in the cells in the sample from its concentration and estimated the yield of the device. Almost 20% of the DNA is extracted from the sample when the applied voltages are 200 V and 300 V as shown in FIG. 14. This measure is useful for determining the efficacy of the device in the field. The relatively low yield may be due to adherence of the DNA in the cell debris or on the internal surfaces of the devices itself.

### SUMMARY

A simple and rapid cell lysis system using low voltage has been fabricated and tested using E. coli cells. The device is remarkable in that it integrates trapping and lysis of cells. A threshold electric field below which the device operates predominantly as an accumulator of cells suspended in the microchannel and above which it starts to lyse the accumulated cells was also determined. For instance, the application of 50 V (electric field 308 V/cm) to the device with a flow rate in the channel of 100 μl/hr led to rapid accumulation of cells on top of the membrane. Subsequent to the accumulation when normal E. coli with propidium iodide has been used, application of 300 V (electric field 1850 V/cm) led to the change in color to red indicating that the cells have been lysed. Characterization of flow rate, voltage and direction of electric field allowed the determination of optimal operating parameters. Using the best condition 90% of bacterial cells have been lysed. Embedding the electrodes very near to the membrane is expected to reduce the operational voltage required for cell lysis. Furthermore, devices are contemplated that integrate the DNA amplification with lysis.

### Example 2

### Integrated Cellular Lysis and Amplification of Nucleic Acids

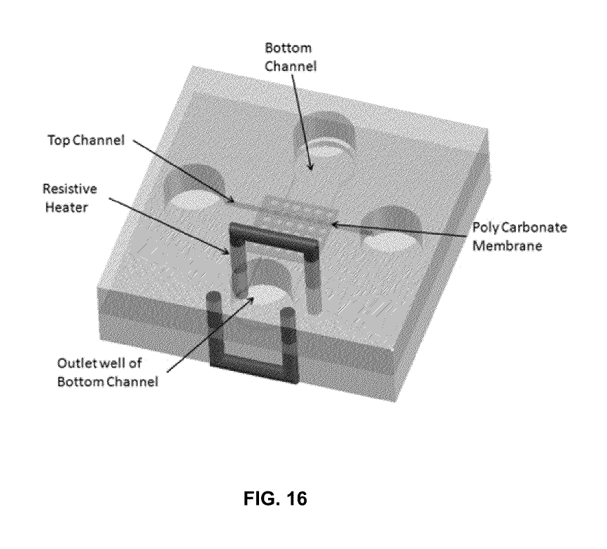

In order to demonstrate integrated lysis, extraction and amplification of nucleic acid molecules in the microfluidic device, a high resistive NiCr heater wire was inserted at the reservoir in the bottom channel as shown in FIG. 16. A loop mediated isothermal amplification (LAMP) method was used to demonstrate the integrated device. A LAMP amplification mixture consisting of the primers and amplification enzymes and buffers were loaded into the bottom channel. The sample was flown in the top channel past the nanoporous membrane and electric field applied to lyse and extract the DNA. Subsequent to extraction, the heater was turned on and the temperature maintained at 65 C with the use of a thermocouple. The amplified solution in the bottom channel was loaded into the fluorimeter to quantify the fluorescence.

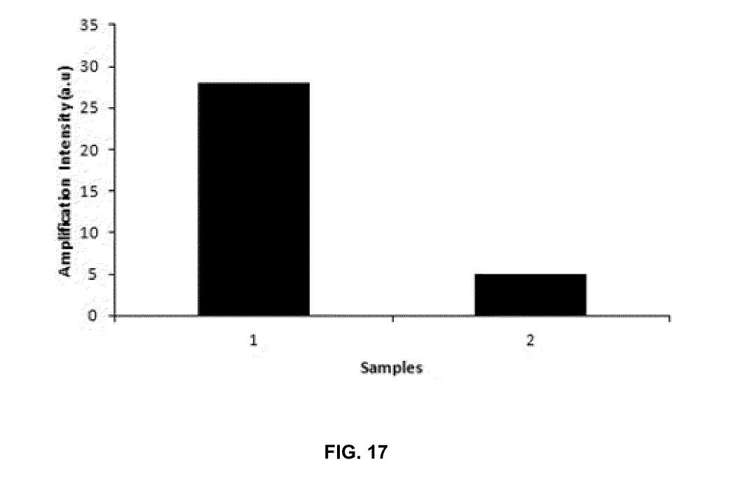

FIG. 17 shows the difference in values between the positive sample which contains the DNA of interest and the negative sample that does not. It can be seen that the intensity of the positive sample is higher and hence is indicative of the presence of the DNA of interest in the sample. Devices wherein a detector and light source suitable for detecting the fluorescence of a target molecule are also contemplated that would be beneficial for the read out and operation of the device.

It will be appreciated that certain features of the invention, which are, for clarity, described in the context of separate embodiments or separate aspects, may also be provided in combination in a single embodiment. Conversely, various features of the invention, which are, for brevity, described in the context of a single embodiment or aspect, may also be provided separately or in any suitable sub-combination.

Although the invention has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present invention.

All publications, patents and patent applications are herein incorporated by reference in their entirety to the same extent as if each individual publication, patent or patent application was specifically and individually indicated to be incorporated by reference in its entirety.

### REFERENCES

1. M. A. Grant, Applied and Environmental Microbiology, 1997, 63, 3526-30.
2. H. Xu, N. Roberts, F. L. Singleton, R. W. Attwell, D. J. Grimes, and R. R. Colwelp, 1982, 313-323.
3. D. R. Reyes, D. lossifidis, P.-A. Auroux, and A. Manz, Analytical Chemistry, 2002, 74, 2623-36.
4. M. W. Shinwari, D. Zhitomirsky, I. A. Deen, P. R. Selvaganapathy, M. J. Deen, and D. Landheer, Sensors (Basel, Switzerland), 2010, 10, 1679-715.
5. J. A. Hall, E. Felnagle, M. Fries, S. Spearing, L. Monaco, and a Steele, Planetary and Space Science, 2006, 54, 1600-1611.
6. A. M. Skelley, J. R. Scherer, A. D. Aubrey, W. H. Grover, R. H. C. Ivester, P. Ehrenfreund, F. J. Grunthaner, J. L. Bada, and R. a Mathies, Proceedings of the National Academy of Sciences of the United States of America, 2005, 102, 1041-6.
7. A. Wainright, U. T. Nguyen, T. Bjornson, and T. D. Boone, Electrophoresis, 2003, 24, 3784-92.
8. Y. Li, J. S. Buch, F. Rosenberger, D. L. DeVoe, and C. S. Lee, Analytical Chemistry, 2004, 76, 742-8.
9. J. M. Graham and D. Rickwood, Subcellular Fractionation: A Practical Approach, Oxford University Press, 1997.
10. P. C. Li and D. J. Harrison, Analytical Chemistry, 1997, 69, 1564-8.
11. X. Chen, D. Cui, C. Liu, and H. Cai, Chinese Journal of Analytical Chemistry, 2006, 34, 1656-1660.
12. C. Prinz, J. O. Tegenfeldt, R. H. Austin, E. C. Cox, and J. C. Sturm, Lab on a Chip, 2002, 2, 207-12.
13. Y. Huang, E. L. Mather, J. L. Bell, and M. Madou, Analytical and Bioanalytical Chemistry, 2002, 372, 49-65.
14. D. Di Carlo, K.-H. Jeong, and L. P. Lee, Lab on a Chip, 2003, 3, 287-91.
15. A. Ben-or and B. Rubinsky, Science, 2010, 63-83.
16. H. J. Lee, J.-H. Kim, H. K. Lim, E. C. Cho, N. Huh, C. Ko, J. C. Park, J.-W. Choi, and S. S. Lee, Lab on a Chip, 2010, 10, 626-33.
17. E. a Schilling, A. E. Kamholz, and P. Yager, Analytical Chemistry, 2002, 74, 1798-804.
18. G. Ocvirk, H. Salimi-moosavi, R. O. D. J. Szarka, E. A. Arriaga, P. E. R. E. Andersson, R. Smith, N. J. Dovichi, and D. J. E. D. Harrison, 2004, 92, 115-125.
19. C. L. Colyer and D. J. Harrison, Electrophoresis, 1997, 18, 1733-1741.
20. A. Abolmaaty, M. G. EI-Shemy, M. F. Khallaf, and R. E. Levin, Journal of Microbiological Methods, 1998, 34, 133-141.
21. J. Kim, S. Hee Jang, G. Jia, J. V Zoval, N. a Da Silva, and M. J. Madou, Lab on a Chip, 2004, 4, 516-22.
22. D. Di Carlo, C. Ionescu-Zanetti, Y. Zhang, P. Hung, and L. P. Lee, Lab on a Chip, 2005, 5, 171-8.
23. W. Wan and J. T. W. Yeow, Biomedical Microdevices, 2011, 13, 527-32.
24. E. Neumann; M. Schaefer-Ridder; Y. Wang and P. H. Hofscheider, The EMBO Journal, 1982, 1, 841-845.
25. L. V Chernomordik, S. I. Sukharev, S. V Popov, V. F. Pastushenko, a V Sokirko, I. G. Abidor, and Y. a Chizmadzhev, Biochimica et Biophysica Acta, 1987, 902, 360-73.
26. W. K. Neu, Science, 2010, 85-122.
27. S. W. Lee, H. Yowanto, and Y. C. Tai, Proceedings MEMS 98. IEEE. Eleventh Annual International Workshop on Micro Electro Mechanical Systems. An Investigation of Micro Structures, Sensors, Actuators, Machines and Systems (Cat. No. 98CH36176), 1999, 443-447.
28. J. Gao, X.-F. Yin, and Z.-L. Fang, Lab on a Chip, 2004, 4, 47-52.
29. C. de la Rosa and K. V. I. S. Kaler, Conference proceedings: Annual International Conference of the IEEE Engineering in Medicine and Biology Society. IEEE Engineering in Medicine and Biology Society. Conference, 2006, 1, 4096-9.
30. N. Bao and C. Lu, Applied Physics Letters, 2008, 92, 214103.
31. H.-Y. Wang, A. K. Bhunia, and C. Lu, Biosensors &Bioelectronics, 2006, 22, 582-8.
32. D. W. Lee and Y.-H. Cho, Sensors and Actuators B: Chemical, 2007, 124, 84-89.
33. E. Neumann, A. E. Sowers, and C. A. Jordan, Electroporation and Electrofusion in Cell Biology, Plenum Press, 1989.
34. S. Y. Ho and G. S. Mittal, Critical reviews in Biotechnology, 1996, 16, 349-62.
35. T. Y. Tsong, Biophysical journal, 1991, 60, 297-306.
36. U. Zimmermann, Rev Physiol Biochem Pharmacol, 1986, 105, 175-256.
37. T. Y. Tsong, Bioelectrochemistry and Bioenergetics, 1990, 24, 271-295.
38. S. Movahed and D. Li, Microfluidics and Nanofluidics, 2010, 10, 703-734.
39. J. M. Song and E. S. Yeung, Electrophoresis, 2001, 22, 748-54.
40. J. C. Mcdonald, D. C. Duffy, J. R. Anderson, and D. T. Chiu, Electrophoresis, 2000, 21, 27-40.
41. and C. L. Hsiang-Yu Wang, Padamapriya P. Banada, Arun K. Bhunia, Methods in Molecular Biology (Clifton, N.J.), 2007, 385, 25-35.
42. H. Wang and C. Lu, Biotechnology and Bioengineering, 2006, 95, 1116-1125.

1. A microfluidic device comprising:
a first microchannel;
a second microchannel;
a nanoporous membrane comprising a plurality of pores separating the first microchannel from the second microchannel;
a first electrode positioned within the first microchannel and a second electrode positioned with the second microchannel for applying an electric potential across the nanoporous membrane so that when an electric potential is applied cells in the first microchannel are attracted to the nanoporous membrane.

2. The microfluidic device of claim 1, wherein the first microchannel comprises a sample inlet and a sample outlet and the nanoporous membrane is positioned between the sample inlet and the sample outlet such that a liquid sample flowing through the first microchannel from the sample inlet to the sample outlet flows past the nanoporous membrane.

3. The microfluidic device of claim 1, wherein the second microchannel comprises an inlet and an outlet and the nanoporous membrane is positioned between the second microchannel inlet and the second microchannel outlet.

4. The microfluidic device of claim 1, wherein the first microchannel and/or second microchannel comprises polydimethyl siloxane (PDMS).

5. The microfluidic device of claim 1, wherein the pores allow for the passage of biomolecules between the first microchannel and the second microchannel and do not allow for the passage of cells from the first microchannel to the second microchannel.

6. The microfluidic device of claim 1, wherein the pores have a diameter between 1 nm and 1 um.

7. The microfluidic device of claim 1, wherein the nanoporous membrane comprises polyvinylpyrrolidone (PVP) coated polycarbonate.

8. The microfluidic device of claim 1, further comprising at least one pump for controlling the flow of a liquid sample through the first microchannel.

9. The microfluidic device of claim 1, wherein the one or more target biomolecules are nucleic acids.

10. The microfluidic device of claim 1, wherein the device further comprises a heating element for heating the second microchannel and performing thermal-based amplification of one or more nucleic acid molecules in the second microchannel.

11. A method for processing and lysing cells, the method comprising:
introducing a sample comprising one or more cells into a first microchannel;
applying a first electric potential across a nanoporous membrane separating the first microchannel from a second microchannel to generate an electrophoretic force acting on the cells in the first microchannel so that the cells in first microchannel are attracted to the nanoporous membrane; and
applying a second electric potential across the nanoporous membrane so that the cells attracted to the surface of the nanoporous membrane are lysed releasing one or more biomolecules and the one or more biomolecules are forced across the nanoporous membrane into the second microchannel by an electrophoretic force acting on the one or more biomolecules.

12. The method of claim 11, comprising continuously or intermittently flowing the sample through the first microchannel past the nanoporous membrane.

13. The method of claim 12, wherein the flow of the sample in the first microchannel is in the same direction as the electrophoretic force acting on the one or more cells in the first microchannel or

14. The method of claim 12, wherein the flow of the sample in the first microchannel is in the opposite direction as the electrophoretic force acting on the one or more cells in the first microchannel.

15. The method of claim 11, wherein the first electric potential is the same as the second electric potential and the one or more cells in the first microchannel are simultaneously attracted to the nanoporous membrane and lysed.

16. The method of claim 11, wherein the first electric potential is less than the second electric potential and the first electric potential is applied across the nanoporous membrane for a first time period such that the concentration of cells in the first microchannel near the nanoporous membrane is increased prior to applying the second electric potential and lysing the cells.

17. The method of claim 11, further comprising assaying the biomolecules in the second microchannel for the presence or absence of one or more target biomolecules.

18. The method of claim 17, wherein the one or more target biomolecules are assayed in situ in the second microchannel.

19. The method of claim 17, wherein the one or more target biomolecules comprises one or more nucleic acids.

20. The method of claim 11, wherein the nanoporous membrane allows for the passage of biomolecules between the first microchannel and the second microchannel and does not allow for the passage of cells from the first microchannel to the second microchannel.

21. The method of claim 11, wherein the nanoporous membrane comprises polyvinylpyrrolidone (PVP) coated polycarbonate.
